(19) United States
(12) Patent Application Publication
(10) Pub. No.: US 2003/0164565 A1
(43) Pub. Date: Sep. 4, 2003

(54) Method of fabricating an injection mold insert for molding lens molds

(76) Inventor: Keith T. O'Brien, Jacksonville, FL (US)

Correspondence Address: AUDLEY A. CIAMPORCERO JR., JOHNSON & JOHNSON, ONE JOHNSON & JOHNSON PLAZA, NEW BRUNSWICK, NJ, 08933-7003, US

(21) Appl. No.: 10/371,144

(22) Filed: Feb. 20, 2003

Related U.S. Application Data
(60) Provisional application No. 60/361,904, filed on Mar. 4, 2002.

(51) Int. Cl. B29D 11/00

(52) U.S. Cl. 264/2.5; 425/808; 249/134; 425/135; 425/352; 264/219; 205/70; 156/60

(57) ABSTRACT

An injection mold insert and a method of fabricating an injection mold insert for molding lens molds which provides a plurality of replicates of a single master mold mandrel which may be produced, for example, by diamond point. The mandrel is used to electroform an electroform mold insert component having an optical quality surface which forms a surface of an injection mold. An adhesive is used to fixedly attach the electroform mold insert to a separately machined mold insert substrate.

### CROSS REFERENCE TO RELATED APPLICATION

The present application claims the benefit of U.S. Provisional Application Serial No. 60/361,904, which was filed on Mar. 4, 2002.

### BACKGROUND OF THE INVENTION

1. Field of the Invention

The present invention relates generally to an injection mold insert and a method of fabricating an injection mold insert for molding lens molds which provides a plurality of replicates of a single master mold mandrel which may be produced, for example, by diamond point machining. The mandrel is used to electroform an electroform mold insert component having an optical quality surface which forms a surface of an injection mold. An adhesive is used to fixedly attach the electroform mold insert to a separately machined mold insert substrate.

The subject invention provides substantial reductions in the cost of manufacturing soft contact lenses produced by replicated mold inserts in an automated manufacturing and molding process wherein a replicated mold insert is used to manufacture optical grade plastic mold parts, each of which is used only once to mold a soft contact lens therein and is then disposed of.

2. Discussion of the Prior Art

The state of the art of manufacturing hydrogel soft contact lenses has progressed to automated molding systems and assembly lines in which each hydrogel soft contact lens is formed by sandwiching a monomer between front curve (FC) and back curve (BC) mold section halves. The monomer is polymerized to form a lens, which is then removed from the mold section halves, further treated and then packaged for consumer use.

In a typical prior art soft contact lens manufacturing process, metal inserts are used in an injection molding machine in an injection molding process to produce many thermoplastic injection molded front curve (FC) molds and back or base curve (BC) molds, each of which FC and BC molds is subsequently used only once to mold a single soft hydrogel contact lens. In this process, the thermoplastic FC mold is dosed with contact lens forming monomer, the BC mold is carefully placed upon the FC mold and the two mold halves pressed together, with excess monomer being expelled into the space outside the optical surfaces of the mold halves. The monomer is then polymerized to form a lens, which is then removed from the mold and further processed to yield the final soft hydrogel lens product.

FIG. 1 is a side elevational sectional view of a typical prior art mold assembly which includes a FC mold half 10 and a BC mold half 12 which define a volume therebetween in which a soft contact lens 14 is molded.

The FC mold half 10 defines a central curved section with an optical quality concave surface 12, which has a circular circumferential well defined sharp edge 16 extending therearound. The sharp edge 16 is desirable to form a well defined and uniform plastic radius parting line (edge) for the subsequently molded soft contact lens. Similarly, the BC half 12 defines a central curved section with an optical quality convex surface.

The FC and BC molds may be manufactured from any thermoplastic material which is capable of being injection molded and which provides the final cast lens with the required optical properties, with preferred materials for mold frames being polystyrene and polypropylene. To injection mold the FC and BC molds, injection metal tool inserts of the required configuration are typically machined and mounted in the injection molding machine. The injection molded FC and BC molds are close and reproducible inverse reproductions of the injection metal mold inserts, and the resultant molded contact lenses are close and reproducible reproductions of FC and BC molds.

The injection mold inserts disclosed and illustrated in U.S. Pat. Nos. 5,702,735 and 5,861,114, are two piece steel inserts which have extremely long lives, but require costly stacking and aligning operations during assembly into the injection mold.

Some prior art two piece steel injection mold inserts have a zero vent design which eliminates a vent and reduces the machining time. These inserts also have extremely long lives, but also require costly stacking and aligning operations during assembly into the injection mold.

Other prior art injection mold inserts are single piece mold inserts and eliminate the need for stacking, but have reduced lives compared to steel mold inserts.

Some prior art injection mold inserts used for manufacturing toric contact lens products are single piece brass inserts of short life, with no stacking and aligning requirement.

An electroform can be attached to a mold substrate by brazing, but the brazing step causes unacceptable distortion of the optical quality surface of the mold insert, such that brazing is not a viable assembly method thereof, and neither is soldering a viable assembly method.

### SUMMARY OF THE INVENTION

Accordingly, it is a primary object of the present invention to provide an injection mold insert and a method of fabricating an injection mold insert for molding lens molds which reduces the cost of injection mold inserts, reduces the variability of substantially identical replicated injection mold inserts, extends the range of injection mold inserts, and maintains the capabilities of existing injection mold inserts.

The present invention provides an injection mold insert and a method of fabricating an injection mold insert for molding lens molds which provides a plurality of replicates of a single master mold mandrel which may be produced, for example, by diamond point machining. The mandrel is used to electroform an electroform mold insert component having an optical quality surface which forms a surface of an injection mold. A substrate mold insert component is machined separately, and supports and is fixedly attached to the electroform mold insert component by an adhesive.

The present invention provides an injection mold insert and a method of replicating mold inserts which provides substantial reductions in the cost of manufacturing soft contact lenses produced by the replicated mold inserts in an automated manufacturing and molding process.

### BRIEF DESCRIPTION OF THE DRAWINGS

The foregoing objects and advantages of the present invention for a method of fabricating an injection mold insert for molding lens molds may be more readily understood by one skilled in the art with reference being had to the following detailed description of several embodiments thereof, taken in conjunction with the accompanying drawings wherein like elements are designated by identical reference numerals throughout the several views, and in which:

FIG. 1 is a side elevational sectional view of a typical prior art mold assembly which includes a front curve mold half and a back curve mold half which define a volume therebetween in which a soft contact lens is molded.

FIG. 2 is a front perspective view of an electroform-manufactured front or base curve mold insert constructed pursuant to the teachings of the present invention.

FIG. 3 is a sectional view through the center of the electroform manufactured mold insert of FIG. 2, and illustrates in greater detail the assembly of an electroform manufactured optical quality electroform insert component to a substrate insert component by an adhesive pursuant to the teachings of the present invention.

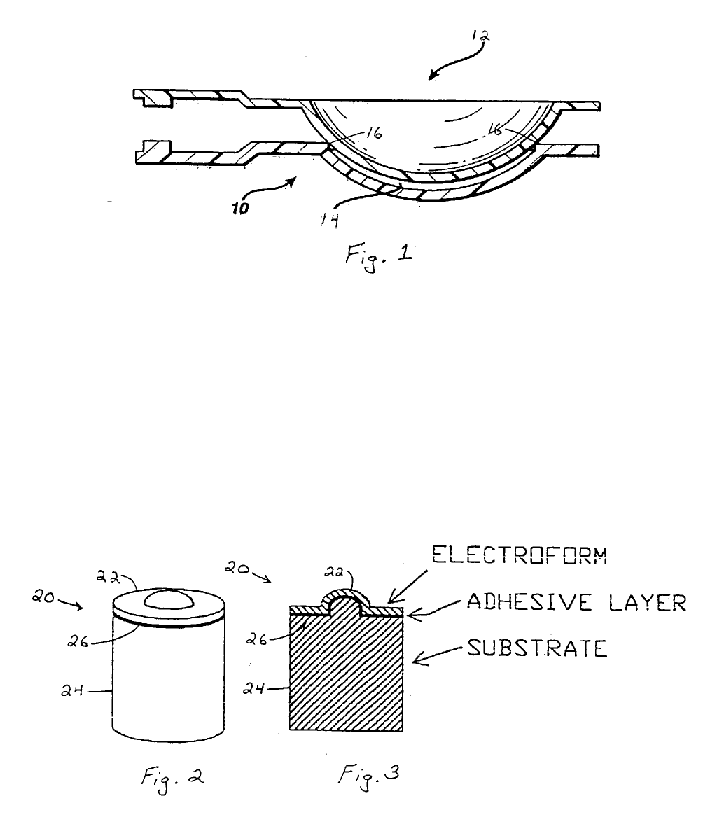

### DETAILED DESCRIPTION OF THE INVENTION

Optical mold inserts have an optical quality surface to mold optical components therefrom, and are relatively expensive and difficult to fabricate. The number of optical mold inserts required for the commercial production of soft contact lenses will be very high in the future; the number of stock keeping units (SKUs) of soft contact lenses will increase significantly in the future with the continued introduction of new products for bifocals, torics, etc.

All optical mold inserts in a mold block should in principle be identical, and as a practical matter, replicates of a master mold insert should be sufficiently closely identical to the master mold such that the final end products of soft contact lenses are commercially acceptable products. It would be attractive if a single master optical mold insert machined, for example, by single point diamond turning could be reproduced or replicated to produce multiple replicated copies thereof, which would result in a substantially less costly manufacturing process for the soft contact lenses.

Electroform pulse-plating is a process which potentially can be used for this purpose, with the application of an electroforming process to the production of replicated optical mold inserts. Usually only a thin shell of a metal such as nickel which reproduces only one surface is fabricated by an electroforming process, whereas optical mold inserts are solid three dimensional parts which require precise accurate overall dimensions.

Moreover, the thermal conductivity of the replicated optical mold inserts must be high, uniform and controlled as the mold inserts should be capable of being rapidly heated and cooled during the commercial molding process.

If only an optical top part or portion of a master optical mold insert is replicated or copied, the replicated top part must be capable of being joined to a substrate or base part of the optical mold insert with high accuracy (with concentric alignment as well as total length) with a very fine tolerance. Also the joint therebetween must be relatively uniform and not have any air-gaps. It is particularly important in the replication of mold inserts that the replicated mold inserts have a longitudinal height or length and concentric alignment which are precisely reproduced within commercially acceptable tolerances.

A process has been developed for electroform pulse-plating which produces totally stress free parts with stable dimensions, and also results in superior uniformity and control of the thickness of the deposited or plated layer. This process is currently being used to produce high precision optical molds for mixed diffractive and regular optics. The electroform pulse-plating process disclosed in patent application EP 0 835 335 B1, published on Sep. 8, 1999, is applicable and suitable to the present invention. However, other prior art electroform pulse-plating processes may also have utility in the practice of the present invention.

FIG. 2 is a front perspective view of an electroform-manufactured base or front curve mold insert 20. FIG. 3 is a sectional view through the center of the electroform-manufactured mold insert 20 of FIG. 2, and illustrates in greater detail the assembly of an electroform-manufactured, optical quality, electroform insert mold component 22 to a substrate insert mold component 24 by a suitable 26 pursuant to the teachings of the present invention.

The mold insert 20 shown in FIGS. 2 and 3 can be manufactured by using a mandrel or master mold, from which many electroform insert components 22 as shown in FIGS. 2 and 3 are reproduced.

The mandrel is preferably produced by precise machining of the optical quality surface thereof, such as by diamond point machining. The optical quality surface of the mandrel is then used to electroform many electroform insert components 22 thereon by an electroform process, as is known in the art.

The mandrel can be produced as a solid one piece mandrel, or alternatively the mandrel can be produced as a two piece mandrel, wherein the optical quality surface is preferably machined on a component which is then joined to a mandrel substrate component to form the complete mandrel. The mandrel is preferably fabricated in two component pieces, a precision machined piece having a machined optical quality surface and a substrate piece. The two component parts can be fabricated from steel or nickel coated copper alloys, and are then assembled to create a sharp corner to form the sharp edge 16, which is more difficult to achieve with a single piece insert construction. The two pieces of the mandrel need to be stacked and aligned only once during assembly, rather than requiring stacking and aligning each time an insert in used and suffering low tolerances as a consequence thereof. The two components are preferably joined by a suitable adhesive, similar to the manufacture of the two piece adhesively joined mold insert of the present invention. Then the mandrel is used to electroform (eform) insert components 22, as illustrated in FIGS. 2 and 3, with a high degree of accuracy and with surface finishes.

The electroform component 22 duplicates the precision machined optical quality surface of the mandrel. The duplication is a negative if performed once and a positive if performed twice sequentially. This duplication allows fabrication of inserts which cannot be machined in a concave base curve insert, by machining in a convex curve mandrel and then electroforming a negative concave curve insert component 22. Also, since many electroform insert components 22 of identical dimensions may be fabricated from a single mandrel, insert to insert variations are reduced.

The surface of the electroform insert component 22 is a mirror image of the desired contact lens front surface or back surface, and is preferably manufactured with a thickness between 0.2 and 1.5 mm. As explained hereinabove, the convex optical quality surface of the BC mold may be the result of two forming steps, such that the original machining work is performed on a convex surface.

Prior to the electroform plating of a layer onto the optical quality surface of the mandrel master mold, the optical quality surface of the mandrel can be passivated to prevent the coated layer from adhering to the optical quality surface. Various passivation techniques are well known in the art, and include the formation of a thin separation oxidation layer over the surface, such as by an electrolytic oxidation process wherein the electrolytic current and voltage are controlled to control the thickness of the oxidation layer, or by chemical passivation techniques such as wherein an albumin (protein) separation layer is deposited onto the surface by immersing the surface in an albumin solution for a controlled period of time, or by immersing the surface in a potassium bichromate solution for a controlled period of time.

The substrate mold insert component can be precisely machined with precise dimensions and tolerance, but does not require an optical quality surface. It can be formed of an alloy based upon at least one metal from the group copper, tin, aluminum, iron, nickel and zinc.

The electroform insert component 22 is then adhesively mounted to an insert substrate component by utilizing an adhesive material having properties of high temperature strength and acceptable resistance to distortion under pressure to withstand the operating conditions of the injection molding equipment. The adhesive should be able to withstand an operating temperature of at least 200° C., have an adhesion strength of at least 60,000 psi, and have a compression strength of at least 60,000 psi. The use of a suitable adhesive permits strain and distortion free mounting of the electroformed insert components 22 onto the insert substrate component 24 and results in improved lens surface quality over that achievable by welding, brazing or soldering. This overall method has considerable economic advantages over the current system of machining each complete mandrel or mold insert to optical quality specifications, with the additional difficulty of machining of a concave surface.

The adhesive layer is preferably thin such that the thermal resistance of the insert is not substantially increased. The structural properties of the adhesive under compression and fatigue loadings is similar to the substrate, such that the mechanical strength of the insert is not significantly reduced.

Epoxy adhesives are preferred adhesives, with Circuit-Bond™ adhesives commercially available from United Resin Corp being particularly suitable to the present invention.

Other suitable adhesives are commercially available from: Abatron, Inc. Kenosha, Wis.; Conap, Lawrenceville, Ga.; Dexter Corp., Aerospace Materials Div., Pittsburgh, Calif.; Dow Corning, Midland, Mich.; Epoxies Etc., Greenville, R.I.; GE Company, GE Silicones, Waterford, N.Y.; United Resin Corporation, Royal Oak, Mich.; and 3M Aerospace, St. Paul, Minn.

An alternative approach to forming a single master mandrel by diamond point is to take advantage of the progress in part formation by focused beams of energy which cause deposition of matter, removal of matter, or reaction of matter to occur in three dimensions in computer controlled processes specific to the procedure being used. More specifically stereo lithothography and fast atom bombardment represent methods of matter deposition, ion beam micromachining is a method of matter removal, and two photon polymerization is a method of reacting matter in a three dimensional framework.

While several embodiments and variations of the present invention for a method of fabricating an injection mold insert for molding lens molds are described in detail herein, it should be apparent that the disclosure and teachings of the present invention will suggest many alternative designs to those skilled in the art.

Having thus described our invention, what we claim as new and desire to secure by Letters Patent is:

1. An injection mold insert comprising:
an electroform mold insert component having a surface which forms a surface of an injection;
a substrate mold insert component which supports and is fixedly attached to the electroform mold insert component;
an adhesive for fixedly securing the electroform mold insert component to the substrate mold insert component.

2. The injection mold insert of claim 1, wherein the injection mold insert is used for fabricating lens molds used in the casting of contact lenses.

3. The injection mold insert of claim 1, wherein the substrate mold insert component is formed of an alloy based upon at least one metal from the group including copper, tin, aluminum, iron, nickel and zinc

4. The injection mold insert of claim 1, wherein the electroform mold insert component is formed of a nickel alloy.

5. The injection mold insert of claim 1, wherein the electroform mold insert has a thickness between 0.2 and 1.5 mm.

6. The injection mold insert of claim 1, wherein the adhesive is an epoxy adhesive.

7. A method of manufacturing an injection mold insert comprising:
electroforming an electroform mold insert component having a surface which forms a surface of an injection mold;
forming a substrate mold insert component which supports and is fixedly attached to the electroform mold insert component;
fixedly securing the electroform mold insert component to the substrate mold insert component by an adhesive.

8. The method of claim 7, including using the injection mold insert for fabricating lens molds used in the casting of contact lenses.

9. The method of claim 7, including forming the substrate mold insert component of an alloy based upon at least one metal from the group including copper, tin, aluminum, iron, nickel and zinc.

10. The method of claim 7, including forming the electroform mold insert component of a nickel alloy.

11. The method of claim 7, wherein the electroform mold insert component is electroformed with a thickness between 0.2 and 1.5 mm.

12. The method of claim 7, including fixedly securing the electroform mold insert component to the substrate mold insert component by an epoxy adhesive.

13. The method of claim 7, including electroforming the electroform mold insert component on a mandrel having an optical quality surface.

14. The method of claim 13, wherein the optical quality surface of the mandrel is produced by diamond point machining.

15. The method of claim 13, wherein the mandrel is fabricated in two components pieces, a precision machined piece having a machined optical quality surface and a substrate piece, and the two pieces of the mandrel are fixedly secured together by an adhesive.

16. The method of claim 15, wherein the two pieces of the mandrel are fixedly secured together by an epoxy adhesive.
